(19) United States
(12) Patent Application Publication
(10) Pub. No.: US 2009/0075122 A1
(43) Pub. Date: Mar. 19, 2009

(54) IMPRINT MOLD STRUCTURE, IMPRINTING METHOD USING THE SAME, AND MAGNETIC RECORDING MEDIUM

(75) Inventors: Masakazu Nishikawa, Kanagawa (JP); Satoshi Wakamatsu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/205,444

(22) Filed: Sep. 5, 2008

(30) Foreign Application Priority Data
Sep. 13, 2007 (JP) 2007-238031

(51) Int. Cl. G11B 3/00

(52) U.S. Cl. 428/826; 264/293

(57) ABSTRACT

The present invention provides an imprint mold structure which can efficiently and uniformly transfer a pattern by enhancing flow of a composition of the imprint resist layer when the imprint mold structure is pressed against the imprint resist layer, an imprinting method of improved transfer accuracy by using the imprint mold structure, and a magnetic recording medium of improved recording and reproduction property. Provided is an imprint mold structure in which at at least any one of an inner circumferential edge and an outer circumferential edge of the concavo-convex patterns in a data area and a servo area of the disc-shaped substrate of the imprint mold structure a dummy pattern is formed which corresponds to a pattern on a magnetic recording medium substrate extending radially from at least any one of an inner circumferential edge and an outer circumferential edge of a pattern forming area.

### BACKGROUND OF THE INVENTION

1. Field of the Invention

The present invention relates to an imprint mold structure, an imprinting method using the imprint mold structure, and a magnetic recording medium.

2. Description of the Related Art

In recent years, hard disc drives that are excellent in speed and cost performance characteristics have begun to be mounted in portable devices such as cellular phones, compact acoustic devices and video cameras as major storage devices.

Furthermore, with increase in market share of hard disc drives as recording devices mounted in portable devices, hard disc drives are requested to meet the demand for further sizing down and increasing capacity, for which it is necessary to develop a technique for increasing recording density.

The recording density of hard disc drives has been conventionally increased by narrowing spaces between data tracks in a magnetic recording medium and by narrowing the magnetic head width.

However, by narrowing spaces between data tracks, effects of magnetism between adjacent tracks (crosstalk) and effects of heat fluctuation become noticeable, thus there is a limitation on improvements in the recording density by the method of narrowing spaces between data tracks.

On the other hand, there is also a limitation on improvements in the surface recording density by the method of narrowing the magnetic head width.

Accordingly, magnetic recording media referred to as discrete track media have been proposed as a solution to noise caused by crosstalk. In the discrete track media, magnetic interference between adjacent tracks is decreased by providing discrete structures in which nonmagnetic guard band regions are provided between adjacent tracks so as to magnetically separate tracks from one another.

Also, magnetic recording media referred to as patterned media, in which bits for recording signals are provided in predetermined patterns of shape, have been proposed as a solution to demagnetization caused by heat fluctuation.

As a method for manufacturing the discrete track media or the patterned media, an imprinting method (imprint process) is used in which a desired pattern is transferred onto a resist layer formed on a surface of a magnetic recording medium by using a resist pattern forming mold (otherwise referred to as “mold”) (see Japanese Patent Application Laid-Open (JP-A) No. 2004-221465).

The imprinting method is specifically a method of coating a substrate to be processed with a thermoplastic resin or a photocurable resin as an imprint resist, firmly attaching and pressing a mold that has been processed in a desired pattern to the resin covering the substrate, curing the resin by heating/cooling or exposing the resin to light, forming a pattern corresponding to the pattern of the mold on the resin by separating the mold from the resin, and patterning the substrate by dry etching or wet etching using the above pattern on the resist as a mask, to obtain the desired magnetic recording medium.

Various improvements of the imprinting method are challenged to form ultrafine patterns on discrete media or patterned media (see JP-A Nos. 2006-120299 and 2005-71487).

In pattern formation on a discrete medium or a patterned medium by the above method, a uniform pattern can be formed well with respect to a narrow partial area of the entire area of a medium, however, it is difficult to form a uniform pattern over a wide area of a medium such as the entire area of a medium.

This may lead to a decreased yield of magnetic recording media and significantly degraded performance of the magnetic recording media.

Thus also in order not to invite the above mentioned results, a method is requested in which a pattern is transferred uniformly over a wide area of a magnetic recording medium and a magnetic recording medium is efficiently manufactured thereby.

### BRIEF SUMMARY OF THE INVENTION

The present invention is carried out in view of such present state of the art, and aims to solve the problems in the prior art and to achieve the following object. Namely an object of the present invention is to provide an imprint mold structure which can uniformly and efficiently transfer a pattern by enhancing flow of a composition of an imprint resist layer when the imprint mold structure is pressed against the imprint resist layer, an imprinting method in which transfer accuracy is improved by using the imprint mold structure, and a magnetic recording medium of improved recording property and reproduction property.

Having earnestly investigated, the present inventors found that in order to enhance flow of a composition forming an imprint resist layer when an imprint mold structure is pressed against the imprint resist layer, concavo-convex portions of a servo area formed continuously in a radial direction in the imprint mold structure may be extended to at least any one of inner circumferential edge and outer circumferential edge of the concavo-convex pattern of the servo area.

The present invention is based on the above findings by the present inventors, and the following are means for solving the aforementioned problems. Namely:
<1> An imprint mold structure including at least a disc-shaped substrate having on a surface thereof concavo-convex patterns in a data area and in a servo area, wherein the concavo-convex pattern in the data area is formed by forming a plurality of convex portions along concentric circumferences on the surface of the disc-shaped substrate, and the concavo-convex pattern in the servo area is formed by radially forming ridges of a plurality of convex portions on the surface of the disc-shaped substrate, wherein the imprint mold structure is used for transferring the concavo-convex pattern onto an imprint resist layer, which is composed of an imprint resist composition formed on a disc-shaped magnetic recording medium substrate, by pressing the concavo-convex patterns in the data area and in the servo area against the imprint resist layer, and wherein at at least any one of an inner circumferential edge and an outer circumferential edge of the concavo-convex pattern in the servo area relative to the center of the disc-shaped substrate of the imprint mold structure, a dummy pattern is formed, which extends radially from at least any one of an inner circumferential edge and an outer circumferential edge of a pattern forming area on the magnetic recording medium substrate.

In the imprint mold structure according to the item <1>, when a desired pattern is transferred onto an imprint resist layer formed on the magnetic recording medium substrate, the cross-sectional area of openings of flow paths of the imprint resist layer is increased by the dummy pattern to increase conductance of the imprint resist layer. This results in uniform pressure over the magnetic recording medium when the imprint mold structure is pressed against the imprint resist layer on the magnetic recording medium, in less occurrence of poor local transfer due to a shape of convex portions (pattern), and in smooth and secure transfer of the desired pattern over the entire surface of the imprint resist layer.
<2> The imprint mold structure according to the item <1>, wherein the dimension of regions of the dummy pattern in a radial direction on the imprint mold structure is in the range of 0.1 mm to 1.0 mm.
<3> The imprint mold structure according to any one of the items <1> and <2>, wherein the width of the concavo-convex pattern in the servo area along the outermost circumference (WO) is larger than the width of the concavo-convex pattern in the servo area along the innermost circumference (WI).
<4> The imprint mold structure according to any one of the items <1> to <3>, wherein the ratio of the width of the concavo-convex pattern in the servo area along the outermost circumference (WO) to the width of the concavo-convex pattern in the servo area along the innermost circumference (WI) (W: W=WO/WI) is in the range of 1.5 to 2.8.
<5> The imprint mold structure according to any one of the items <1> to <4>, wherein the number (N) of convex portions or concave portions of the servo area is in the range of 60 to 300.
<6> An imprinting method including at least transferring a concavo-convex pattern onto an imprint resist layer formed on a magnetic recording medium substrate, by pressing the imprint mold structure according to any one of the items <1> to <5> against the imprint resist layer.
<7> The imprinting method according to the item <6>, wherein conditions for the imprinting method satisfy the following Mathematical Expression 1:

0.001≦P/NW<0.45 Mathematical Expression 1

wherein P represents the viscosity of the imprint resist composition, W represents the ratio of the width of the concavo-convex pattern in the servo area along the outermost circumference (WO) to the width of the concavo-convex pattern in the servo area along the innermost circumference (WI) (W=WO/WI), and N represents the number of convex portions or concave portions of the servo area.
<8> The imprinting method according to any one of the items <6> and <7>, wherein the width of the concavo-convex pattern in the servo area along the outermost circumference (WO) is larger than the width of the concavo-convex pattern in the servo area along the innermost circumference (WI).
<9> The imprinting method according to any one of the items <6> to <8>, wherein the ratio of the width of the concavo-convex pattern in the servo area along the outermost circumference (WO) to the width of the concavo-convex pattern in the servo area along the innermost circumference (WI) (W: W=WO/WI) is in the range of 1.5 to 2.8.
<10> The imprinting method according to any one of the items <6> to <9>, wherein the number (N) of convex portions or concave portions of the servo area is in the range of 60 to 300.
<11> A magnetic recording medium including at least a magnetic pattern portion and a nonmagnetic pattern portion, wherein the magnetic recording medium is manufactured by a method for manufacturing a magnetic recording medium which includes at least transferring a concavo-convex pattern onto an imprint resist layer formed on a magnetic recording medium substrate, by pressing the imprint mold structure according to any one of the items <1> to <5> against the imprint resist layer, forming on a first area of a magnetic layer the magnetic pattern portion of the data area corresponding to the concavo-convex pattern in the data area formed on the imprint mold structure and forming on a second area of the magnetic layer the magnetic pattern portion of the servo area corresponding to the concavo-convex pattern in the servo area formed on the imprint mold structure by etching the first and second area of the magnetic layer formed on a surface of the magnetic recording medium substrate using as a mask the imprint resist layer onto which the concavo-convex pattern has been transferred, and forming the nonmagnetic pattern portion by embedding a nonmagnetic material in a concave portion formed on the magnetic layer, and wherein the width of the magnetic pattern portion of the servo area along the outermost circumference (WO) is larger than the width of the magnetic pattern portion of the servo area along the innermost circumference (WI).
<12> The magnetic recording medium according the item <11>, wherein the ratio of the width of the magnetic pattern portion of the servo area along the outermost circumference (WO) to the width of the magnetic pattern portion of the servo area along the innermost circumference (WI) (W: W=WO/WI) is in the range of 1.5 to 2.8.
<13> The magnetic recording medium according to any one of the items <11> and <12>, wherein the number of magnetic pattern portions of the servo area (N) is in the range of 60 to 300.
<14> The magnetic recording medium according to any one of the items <11> to <13>, wherein the magnetic pattern portions of the servo area are servo pattern.
<15> The magnetic recording medium according to any one of the items <11> to <14>, wherein the magnetic recording medium satisfies the following Mathematical Expression 1:

0.001≦P/NW<0.45 (Mathematical Expression 1)

wherein P represents the viscosity of the imprint resist composition, W represents the ratio of the width of the magnetic pattern portion of the servo area along the outermost circumference (WO) to the width of the magnetic pattern portion of the servo area along the innermost circumference (WI) (W=WO/WI), and N represents the number of magnetic pattern portions of the servo area.

The present invention can provide an imprint mold structure which can efficiently and uniformly transfer a pattern by enhancing flow of a composition of the imprint resist layer when the imprint mold structure is pressed against the imprint resist layer, an imprinting method of improved transfer accuracy by using the imprint mold structure, and a magnetic recording medium of improved recording property and reproduction property.

### BRIEF DESCRIPTION OF THE SEVERAL VIEWS OF THE DRAWINGS

FIG. 1 is a plan view exemplarily showing the configuration of an imprint mold structure according to the present invention.

FIG. 2 is a partial sectional view exemplarily showing the configuration of an imprint mold structure according to the present invention.

FIG. 3A is a cross-sectional view exemplarily showing a method for manufacturing an imprint mold structure according to the present invention.

FIG. 3B is another cross-sectional view exemplarily showing the method for manufacturing an imprint mold structure according to the present invention.

FIG. 4 is a cross-sectional view exemplarily showing a method for manufacturing a magnetic recording medium using an imprint mold structure according to the present invention.

### DETAILED DESCRIPTION OF THE INVENTION

An imprint mold structure according to the present invention will be described with reference to the drawings below.

### (Imprint Mold Structure)

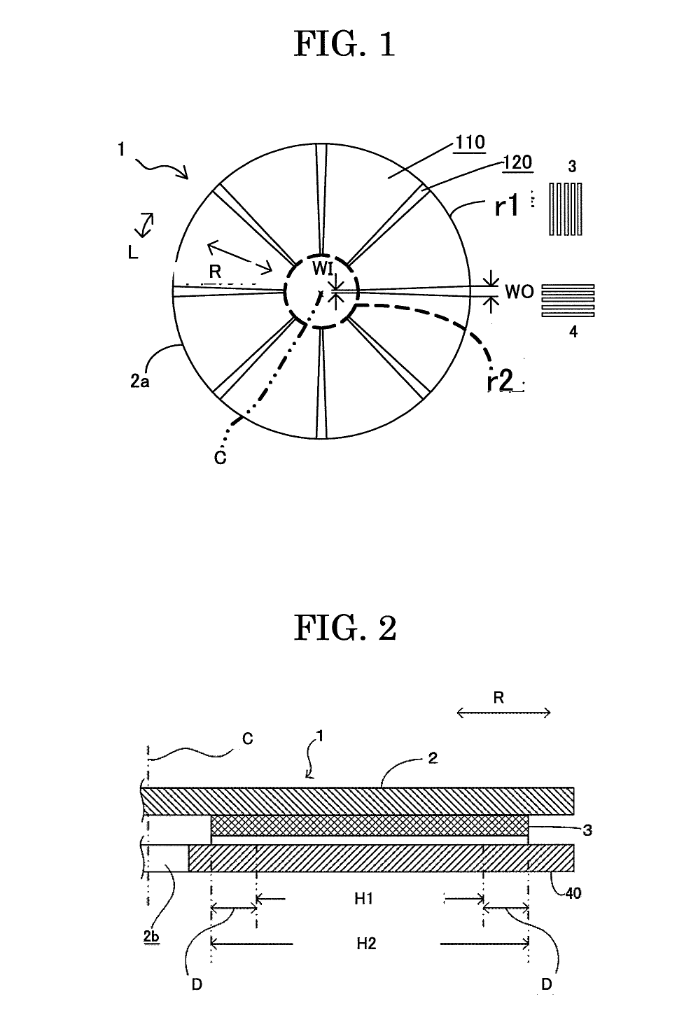

FIG. 1 is a plan view exemplarily showing the schematic configuration of an imprint mold structure according to the present invention. L denotes a circumferential direction, R denotes a radial direction, C denotes the center, r1 denotes the outside diameter, r2 denotes the inside diameter, WI denotes the width of a servo area along the innermost circumference measured based on a concavo-convex pattern in the servo area, and WO denotes the width of the servo area along the outermost circumference measured based on a concavo-convex pattern in the servo area.

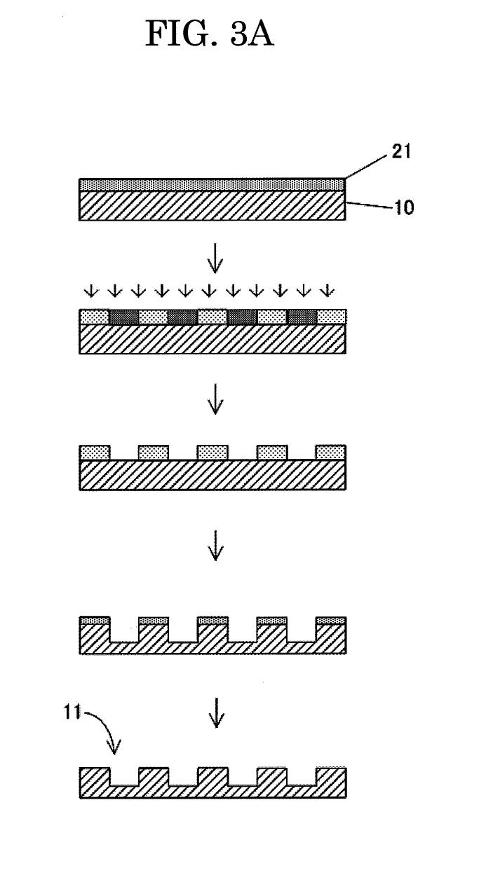

FIG. 2 is a partial sectional view exemplarily showing the configuration of an imprint mold structure according to the present invention. H1 is a pattern forming area, H2 is a total pattern area, and D is a dummy pattern area.

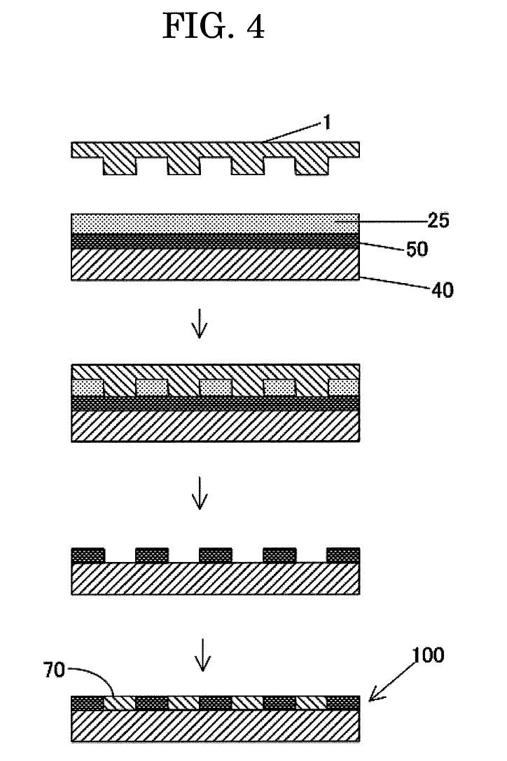

As shown in FIGS. 1 and 2, an imprint mold structure 1 includes at least a disc-shaped substrate 2, a concavo-convex pattern 3 in a data area 110 in which a plurality of convex portions are concentrically formed at predetermined intervals on a surface 2a of the substrate 2 relative to the surface 2a, and a concavo-convex pattern 4 in a servo area 120 in which a plurality of convex portions are radially placed at predetermined intervals on the surface 2a relative to the surface 2a, and other members as required, wherein the imprint mold structure 1 is used for pressing against the subject to be processed (for example, an imprint resist 25 in FIG. 4 described later).

Here, as shown in FIG. 1, each of the servo areas 120 is formed in an equiangular manner so as to provide separate data areas 110.

Furthermore, as shown in FIG. 2, at at least any one of an inner circumferential edge and an outer circumferential edge of the concavo-convex pattern in the data area or the concavo-convex pattern in the servo area a dummy pattern (D), which corresponds to concavo-convex portions on a substrate of the magnetic recording medium extending radially from at least any one of an inner circumferential edge and an outer circumferential edge of a pattern forming area (H1), is preferably formed.

Note that the area of the dummy pattern (D) is, as shown in FIG. 2, set based on the position of the pattern forming area (H1) on the substrate 40 of the magnetic recording medium, with the center of the disc-shaped imprint mold structure being placed on the center of the disc-shaped magnetic recording medium substrate 40 with accuracy within ±50 μm, by extending the dummy pattern radially. When the absolute value of the accuracy is more than 50 μm, adherence of an imprint mold structure 1 to a magnetic recording medium becomes uneven at the time of NIL (nanoimprint lithography) (adherence pressure varies in the magnetic recording medium with changes of contact area between the mold and the magnetic recording medium depending on the angle with which the mold is superimposed on the magnetic recording medium), and evenness of resist pattern degrades.

By forming the dummy pattern, the cross-sectional area of openings of flow paths of an imprint resist layer is increased to enhance conductance of the imprint resist layer. This results in uniform pressure over the magnetic recording medium when the imprint mold structure is pressed against the imprint resist layer on the magnetic recording medium, less occurrence of poor local transfer due to a shape of convex portions (pattern), and smooth and secure transfer of the desired pattern over the entire surface of the imprint resist layer.

Conventionally the concavo-convex pattern in the data area is a concentric concavo-convex pattern, and when the imprint mold is imprinted on the imprint resist layer, redundant resist flows in radial directions along the concavo-convex pattern. Thus an imprint resist pushed out by convex portions of the mold cannot flow smoothly, producing resist pools. These result in difficulty in increasing pressing pressure and in formation of a thick residual film in concave portions of the resist pattern.

In contrast to data areas, servo areas have patterns extending in a radial direction, resulting in relatively small inhibition and resistance in flow paths of an imprint resist (an imprint resist flows linearly) and in easy imprinting of excellent quality in servo areas.

Note that when there are servo areas and data areas in a magnetic recording medium, a redundant resist is produced both for the servo areas and the data areas at the time of imprinting.

Since there are sites connecting a data area to a servo area, a redundant resist in the data area can flow into the servo area. However, the flow direction of a resist is orthogonal between in the data area and in the servo area, conductance of a resist between the data area and the servo area is low. Therefore only a residual resist in the servo area enjoys the smaller inhibition and resistance in flow paths of a servo area and the flow of a residual resist in the data area is inhibited to the degree harder than the flow of a residual resist in the servo area. These result in a thicker residual film being formed in the data area than in the servo area.

The present inventors analyzed resist flow according to a concavo-convex pattern of a mold, and found that dead ends are produced at at least any one of the innermost circumferential edge and the outermost circumferential edge of a concavo-convex pattern in the servo area extending in radial directions and that these dead ends influence the above mentioned thickness of the residual film and the flowability of the resist.

Therefore, improvement strategies by which the above mentioned problems are solved include first of all a strategy to extend at least any one of the outermost circumferential edge and the innermost circumferential edge of a concavo-convex pattern in a servo area and not to produce dead ends. In such a strategy it is important not only to make openings but also to control conductance of flow paths of a resist. When the sizes of opening and the conductance of flow paths of a resist are excessively large, mainly a resist in servo areas flows, and especially in a servo area with an irregular pattern of a sparse part and a dense part a resist flows into the sparse part in a concentrated manner, which is not preferable. When the sizes of opening and the conductance of flow paths of a resist are excessively small, resist flow in servo areas is also inhibited, and a resist becomes difficult to flow into even the sparse part, which is also not preferable. Thus the present inventors found that by setting appropriate sizes of opening and conductance of flow paths of a resist, resist flow of servo areas and data areas is realized in a balanced manner.

The dimension in a radial direction of an area of dummy pattern formed is preferably in the range of 0.1 mm to 1.0 mm. When the dimension is less than 0.1 mm, the conductance becomes excessively small due to small sizes of opening, which lowers the flowability of a resist and generates an uneven residual film of a resist. When the dimension is more than 1.0 mm, the conductance becomes excessively large, which produces a thick residual film in data areas.

The opening means a space formed by concave portions in an extended servo area in the dummy pattern. Thus the opening is a pattern serving as flow paths for an ejected resist extending in a radial direction, not a mere opening provided for the sole purpose of preventing the imprint mold structure from having dead ends at the outermost circumference or the innermost circumference of a servo area. Therefore, the volume of the opening is represented by the product of the length in a radial direction of the dummy pattern in an outermost circumference or an innermost circumference of a servo area and the cross-sectional area of all the concave portions of the outermost circumference or the innermost circumference of the servo area.

Furthermore, the servo area 120 is more preferably formed such that the width in a circumferential direction is enlarged from the inner circumference toward the outer circumference with respect to the substantial center of the substrate 2.

Specifically, the servo area 120 satisfies the following mathematical expression: Wa<Wb, wherein in the servo area Wa represents a first width in a circumferential direction closer to the inner circumference than a second width and Wb represents the second width in a circumferential direction closer to the outer circumference than the first width.

Here, the width of a servo area 120 in the present invention is defined as the distance between two data areas 110 in a given circumferential direction formed so as to sandwich the servo area 120. The distance is measured with respect to the convex portions or the concave portions (of the data areas) which directly sandwich the servo area 120.

The shape of a vertical cross-section of a concavo-convex pattern 3 in a data area taken on a line that has a radial direction of the concentric circles (a direction perpendicular to the direction in which the convex portion extends) is for example rectangular.

The shape of a vertical cross-section of a concavo-convex pattern 3 in a data area taken on a line that has a radial direction of the concentric circles is not limited to rectangle, and can be selected from arbitrary shapes depending on the purpose by controlling an etching process described later.

Hereinafter in the description of the present embodiment, “(shape of) a cross-section” means, unless otherwise stated, the (shape of) a vertical cross-section of a concavo-convex pattern 3 in a data area taken on a line that has a radial direction of the concentric circles (a direction perpendicular to the direction in which the convex portion extends).

### —Other Member—

An additional member is not particularly limited and can be appropriately selected depending on the purpose, as long as it does not impair the effects of the present invention; and an example thereof includes a mold surface layer which is formed on the substrate 2 in layer and provides separability from the imprint resist layer.

### <<Imprint Resist Layer>>

The imprint resist layer is a layer formed by coating a substrate of a magnetic recording medium with an imprint resist composition (hereinafter, otherwise referred to as an “imprint resist solution”).

The imprint resist layer 25 is not particularly limited, can be appropriately selected from those known in the art depending on the purpose, and is a layer formed by coating a substrate 40 of a magnetic recording medium with an imprint resist composition (hereinafter, otherwise referred to as an “imprint resist solution”) containing, for example, at least any one of a thermoplastic resin and a photocurable resin.

For the imprint resist composition forming the imprint resist layer 25, for example, novolac resins, epoxy resins, acrylic resins, organic glass resins and inorganic glass resins are used.

The thickness of the imprint resist layer 25 is preferably 5% to less than 200% of the height of convex portions formed on the surface 2a on a mold 1. When the height is less than 5%, the amount of a resist is insufficient and a desired resist pattern can not be formed.

The thickness of an imprint resist layer can be measured, for example, by separating a part of the resist from the substrate coated with the resist and by measuring the height of a step obtained after the separating with an AFM (DIMENSION5000, manufactured by Veeco Instruments).

### [Viscosity of Imprint Resist Composition]

The viscosity of the imprint resist composition is measured, for example, with an ultrasonic viscosity meter.

An imprint mold structure of the present invention preferably satisfies the following Mathematical Expression 1:

0.001≦P/NW<0.45 Mathematical Expression 1

wherein P (mPa·s) represents the viscosity of the imprint resist composition, N represents the number of convex portions or concave portions 4 of the servo areas, and W represents the ratio of the width of the concavo-convex pattern in a servo area along the outermost circumference (WO) to the width of the concavo-convex pattern in the servo area along the innermost circumference (WI) (W=WO/WI), and wherein 0.5≦P≦70.

W is preferably in the range of 1.5 to 2.8, and the number (N) of concavo-convex portions 4 of the servo areas is preferably in the range of 60 to 300. The number (N) of concavo-convex portions 4 of the servo areas is counted with comparator equipment (MM-800, manufactured by NIKON CORPORATION).

Furthermore, the width WI of a concavo-convex pattern in a servo area along the innermost circumference and the width WO of a concavo-convex pattern in the servo area along the outermost circumference are measured, for example, with comparator equipment (MM-800, manufactured by NIKON CORPORATION).

### <Method for Manufacturing Imprint Mold Structure>

Hereinafter, an example of a method for manufacturing an imprint mold structure according to the present invention will be described, with reference to the drawings. The imprint mold structure according to the present invention may be an imprint mold structure manufactured by a method for manufacuturing an imprint mold structure other than the method described below.

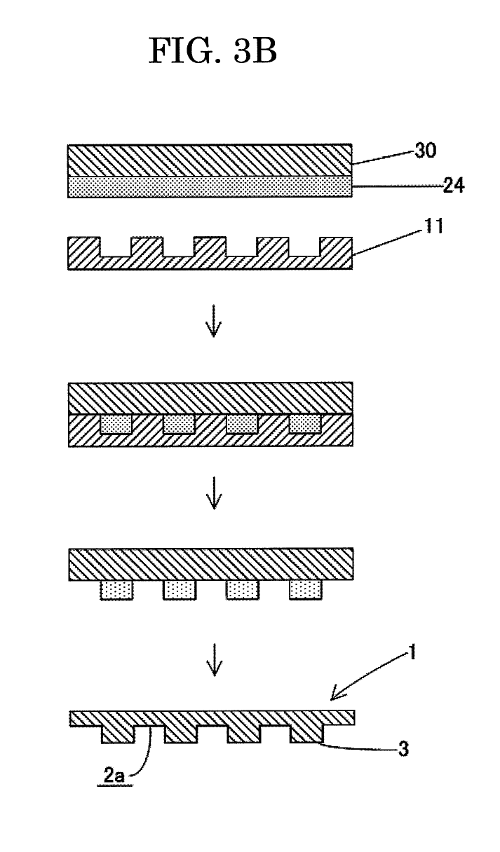

FIGS. 3A and 3B are cross-sectional views exemplarily showing a method for manufacuturing a mold structure 1. First, as shown in FIG. 3A, a photoresist solution, such as a novolac resin or an acrylic resin solution is applied onto an Si base 10 by spin coating or the like to form a photoresist layer 21.

Then the Si base 10 is irradiated with a laser beam (or an electron beam) that is modulated according to a servo signal with the Si base 10 rotating to expose a predetermined pattern at a corresponding part of each frame on tracks over the entire photoresist surface. The predetermined pattern is, for example, a pattern corresponding to a servo signal that extends linearly in a radial direction from the rotational center to each track.

Subsequently, the photoresist layer 21 is developed to remove those portions exposed, the pattern of the photoresist layer 21 from which those portions have been removed is used as a mask and the Si base 10 is selectively etched by RIE or the like to thereby obtain an master plate 11 having a convexo-concave pattern.

For the method for manufacturing a mold by using the master plate 11, a plating method, a nanoimprint method and the like may be used.

The method for manufacturing a mold by a plating method is described below.

First, a conductive layer (not shown) is formed on the surface of the master plate 11. For a method for forming the conductive film, a vacuum film-forming method (such as sputtering and vapor deposition), a nonelectrolytic plating method or the like may be generally used.

For a material used for the conductive layer, a metal or an alloy containing at least one selected from Ni, Cr, W, Ta, Fe and Co may be used. Ni, Co and an alloy of FeCo are preferable. A nonmetal material having conductive property, such as TiO, may also be used as a conductive layer.

The thickness of the conductive layer is preferably in the range of 5 nm to 30 nm, more preferably in the range of 10 nm to 25 nm.

Onto the master plate with the conductive layer formed on the surface thereof, a metal material or an alloy material is deposited by plating until a plated base has a predetermined thickness, and then the plated base is separated from the master plate 11, thereby forming the mold.

For the plating material constituting the mold, Ni, Cr, an alloy of FeCo or the like may be used, and an Ni material is preferably used.

The thickness of the mold 1 after it has been separated from the master plate is preferably in the range of 30 μm to 500 μm, and more preferably in the range of 45 μm to 300 μm. When the thickness is less than 30 μm, the rigidity of the mold is reduced, and sufficient mechanical property cannot be secured.

In addition, use of the mold 1 multiple times in the transfer step (NIL, nanoimprint lithography) makes the mold 1 itself deform, resulting in a significant degradation of properties in practical use. When the thickness of the mold is 500 μm or more, the rigidity of the mold becomes too high to secure tight adhesion between the mold 1 and a substrate 40 of a magnetic recording medium at the time of NIL (nanoimprint lithography).

In order to secure the tight adhesion, an adhesion pressure therebetween needs to be increased, and thus a fatal pattern defect may occur between the mold 1 and the substrate 40 of the magnetic recording medium when a foreign object is incorporated thereinto.

A duplicate of mold 1 may be produced by using the above mentioned mold as the master plate 11.

The method for producing a duplicate of the mold by a nanoimprint method is described below.

As shown in FIG. 3B, an imprint resist solution containing a thermoplastic resin or a photocurable resin is applied onto one surface of a substrate 30 to form an imprint resist layer 24, and then the master plate 11 is pressed against the imprint resist layer to transfer the convex portion pattern formed on the surface of the master plate 11 to the imprint resist layer 24.

Here, predetermined regions of an imprint resist layer 24 corresponding to at least any one of the inner circumferential edge and the outer circumferential edge of a magnetic recording medium may be removed, after the imprint resist layer 24 is formed on the substrate 30. The predetermined regions are preferably regions corresponding to regions of a magnetic recording medium within 1 mm from the inner circumferential edge or the outer circumferential edge. The flowability of the imprint resist 24 can be increased by overlap of the removed regions and the dummy patterns of mold 1.

A material for the substrate 30 is not particularly limited, can be appropriately selected depending on the purpose, as long as it has optical transparency and has a strength to serve as a mold structure 1, and examples thereof include quartz (SiO₂) and organic resins (PET, PEN, polycarbonate and fluorine resins having low glass transition temperatures).

The description “a material has optical transparency” specifically means that when a light beam is incident from a certain surface of the substrate 30 such that the light beam exits from the other surface of the substrate 30 on which the imprint resist layer 24 has been formed, the imprint resist solution is sufficiently cured, and means that the light transmittance of light beam having a wavelength of 400 nm or less emitted from the certain surface to the other surface of the substrate is 50% or more.

Further, the description “a material has a strength to serve as a mold structure” means that the material has such a strength that it is separable and can bear stress without being damaged when a mold structure is pressed against an imprint resist layer 24 formed on a magnetic recording medium substrate 30 under the condition of an average surface pressure of 1 kgf/cm² or more and the imprint resist layer is pressurized.

### —Curing Step—

Then, the transferred pattern is cured by cooling or applying ultraviolet ray to the imprint resist layer 24. When the pattern is cured by exposure to ultraviolet radiation, it may be exposed to ultraviolet radiation for curing after the mold structure is separated from the magnetic recording medium after patterning.

### —Pattern Forming Step—

Subsequently, the substrate is selectively etched by RIE or the like while using the transferred pattern as a mask, thereby obtaining a mold structure 1 having a convexo-concave pattern. Furthermore, an inorganic material may be formed on the surface of the substrate to form a mask of the inorganic material based on the resist mask, and the substrate may be etched using this inorganic material mask to form the mold structure 1.

### (Magnetic Recording Medium)

The following is a description of a magnetic recording medium prepared by using an imprint mold structure according to the present invention, such as a discrete track medium and a patterned medium, with reference to the drawings. Note that the magnetic recording medium according to the present invention may be that prepared by other manufacturing method than the manufacturing method described below, as long as it is prepared by using the imprint mold structure according to the present invention.

As shown in FIG. 4, a mold structure 1 is pressed under pressure against a magnetic recording medium substrate 40 on which a magnetic layer 50 and an imprint resist layer 25 of an imprint resist solution are sequentially formed, such that a pattern of a concavo-convex pattern 3 in a data area and a pattern of a concavo-convex pattern 4 in a servo area 120 both formed on the mold structure 1 are transferred to the imprint resist layer 25.

As an imprint resist composition for the imprint resist layer 25 used in preparation of a magnetic recording medium, the same imprint resist composition as those used for the imprint resist layer 24 in preparation of an imprint mold structure may be employed.

Hereinafter, unless otherwise stated, an “imprint resist layer” and an “imprint resist composition” indicate an imprint resist layer 25 in preparation of a magnetic recording medium, and an imprint resist composition forming the imprint resist layer 25, respectively.

Subsequently, the magnetic layer is etched by using as a mask the imprint resist layer 25 on which a concavo-convex pattern 3 in the data area and a concavo-convex pattern 4 in the servo area 120 have been transferred, thereby the concavo-convex pattern corresponding to the concavo-convex pattern formed on the mold structure 1 is formed on the magnetic layer 50. Then, a nonmagnetic layer 70 is formed by embedding a nonmagnetic material into concave portions in the etched magnetic layer, the surface of the magnetic recording medium with magnetic portions and nonmagnetic portions was flattened, the other steps such as a protective film forming step is carried out as required, and a magnetic recording medium 100 is thereby obtained.

The etching step is a step in which concavo-convex portions corresponding to the resist concavo-convex pattern in a data area on the imprint resist layer 25 are formed on an area of the magnetic layer 50 corresponding to the data area.

As a method for forming the concavo-convex pattern, ion beam etching, reactive chemical etching, wet etching or the like may be used.

As a process gas in the ion beam etching Ar can be used, as an etchant in the reactive chemical etching, CO+NH₃ or chlorine gas may be used.

For other steps, for example, as required, a step of embedding nonmagnetic material such as SiO₂, carbon, alumina, polymer such as polymethylmethacrylate (PMMA) or polystyrene (PS), or a lubricant oil in concave portions of the magnetic layer, a step of smoothing the surface of the magnetic layer, a step of forming a protective film on the smoothed surface with DLC (diamond-like carbon) or the like, and a final step of applying a lubricant oil are exemplified.

The magnetic recording medium of the present invention prepared as above has, on a surface of the substrate thereof, a plurality of magnetic pattern portions of data areas formed concentrically at predetermined intervals and a plurality of magnetic pattern portions of servo areas formed in radial directions of the mold substrate at predetermined intervals with a nonmagnetic material separating the two groups of magnetic pattern portions. Although not shown, the magnetic recording medium substrate is a disc of the same size as the substrate 2 of the imprint mold structure and has a hole in the disc.

In such configuration, a plurality of servo areas are formed in radial directions in an equiangular manner so as to separate a plurality of data areas.

Furthermore, the servo area is more preferably formed such that the width in a circumferential direction is enlarged from an inner circumference toward an outer circumference with respect to the hole of a magnetic recording medium substrate.

Specifically, a servo area more preferably satisfies the following mathematical expression: Wc<Wd, wherein in the servo area Wc represents a first width in a circumferential direction closer to the inner circumference than a second width and Wd represents the second width in a circumferential direction closer to the outer circumference than the first width.

Here, the width of a servo area in the present invention is defined as the distance between a border line of meeting of the servo area and an adjacent data area at the same radius and another border line of meeting of the servo area and the other adjacent data area on the same radius, wherein the servo area and the data area are each defined as an area where there are magnetic pattern portions of the servo area and the data area, respectively.

Also the magnetic recording medium of the present invention preferably satisfies the following Mathematical Expression 1:

0.001≦P/NW<0.45 Mathematical Expression 1

wherein P (mPa·s) represents the viscosity of the imprint resist composition, N represents the number of magnetic pattern portions of the servo areas, and W represents the ratio of the width of the magnetic pattern portion of a servo area along the outermost circumference (WO) to the width of the magnetic pattern portion of the servo area along the innermost circumference (WI) (W=WO/MI), and wherein 0.5≦P≦70.

The W is more preferably in the range of 1.5 to 2.8, and the number (N) of magnetic pattern portions of the servo areas is more preferably in the range of 60 to 300.

Furthermore, the width WI of a magnetic pattern portion of the servo area along the innermost circumference and the width WO of a magnetic pattern portion of the servo area along the outermost circumference are measured, for example, with comparator equipment (MM-800, manufactured by NIKON CORPORATION).

### EXAMPLES

Hereafter, Examples of the present invention will be described, however, the present invention is not limited to the following Examples in any way.

### Example 1

### <Preparation of Imprint Mold Structure>

### <<Preparation of Master Plate>>

An electron beam resist was applied onto a disc-shaped Si substrate of 8 inch in diameter by spin coating to form a layer of 100 nm in thickness.

Subsequently, the electron beam resist was exposed with a desired pattern by a rotary electron beam exposing apparatus, and then subjected to a developing process to form an electron beam resist having a concavo-convex pattern on a Si substrate.

The resist-coated Si substrate was subjected to reactive ion etching using as a mask the electron beam resist having a concavo-convex pattern to form a concavo-convex pattern on the Si substrate.

Thereafter, a residual electron beam resist was removed by washing with a solvent capable of dissolving it, and the Si substrate was dried to prepare a master plate.

Broadly, the concavo-convex patterns were divided into concavo-convex patterns in data areas and concavo-convex patterns in servo areas.

Data areas were formed of a concavo-convex pattern in which a convex portion is 120 nm in width and a concave portion is 30 nm in width (the track pitch is 150 nm).

A servo area had a basic signal length of 90 nm and a total sector number of 50 and was formed of a preamble portion (45 bit), an SAM portion (10 bit), a sector code portion (8 bit), a cylinder code portion (32 bit), and a burst portion.

The SAM portion employed the number “0000101011”, a concavo-convex pattern in the sector code portion was formed using Binary conversion, and a concavo-convex pattern in the cylinder code portion was formed using Gray conversion.

A concavo-convex pattern in the burst portion employed a typical phase burst signal (16 bit) and was formed using Manchester conversion.

Subsequently, a novolac resist (Microresist company; mr-I7000E) was applied onto a quartz substrate by spin coating (at 3,600 rpm) to form a layer of 100 nm in thickness.

Then the quartz substrate with a novolac resist layer was subjected to nanoimprinting using the master plate as a mold.

The quartz substrate was etched by RIE employing CHF₃ as an etchant using the resist concavo-convex pattern formed after the nanoimprinting, to obtain an imprint mold structure 1. Note that a releasing layer was formed by a wet 15 method on the surface (the surface which is pressed against a resist layer on a magnetic recording medium) of the imprint mold structure 1 thus prepared. For a releasing agent constituting the releasing layer, EGC-1720 (manufactured by Sumitomo 3M Limited) was used.

A dummy pattern with the dimension indicated in Table 1 was provided in an area of the mold structure 1 corresponding to the area on a magnetic recording medium substrate which extends internally from the innermost circumferential edge of a pattern forming area.

### <<Measurement of Width of Concavo-Convex Pattern in Servo Area>>

For the imprint mold structure thus prepared, WO and WI, widths of the concavo-convex pattern in a servo area, were measured. The results are shown in Table 1.

### <<Number of Convex Portions or Concave Portions of Servo Areas>>

For the imprint mold structure thus prepared, the number of convex portions or concave portions of the servo areas was counted with comparator equipment (MM-800, manufactured by NIKON CORPORATION). The result is shown in Table 1.

### <Preparation of Magnetic Recording Medium>

Layers were deposited over a 2.5-inch glass substrate in the following manner to prepare a magnetic recording medium. In the magnetic recording medium thus prepared, a soft magnetic layer, a first nonmagnetic orientation layer, a second nonmagnetic orientation layer, a magnetic layer (otherwise referred to as a magnetic recording layer), a protective layer, and a lubricant layer were sequentially formed.

The soft magnetic layer, first nonmagnetic orientation layer, second nonmagnetic orientation layer, magnetic recording layer, and protective layer were formed by sputtering, and the lubricant layer was formed by a Dip method.

### <Formation of Soft Magnetic Layer>

As the soft magnetic layer, a layer of 100 nm in thickness composed of CoZrNb was formed.

Specifically, the glass substrate was set facing the CoZrNb target, then Ar gas was injected such that its pressure became 0.6 Pa, and the soft magnetic layer was formed at 1,500 W (DC).

### <Formation of First Nonmagnetic Orientation Layer>

As the first nonmagnetic orientation layer, a Ti layer of 5 nm in thickness was formed.

Specifically, the soft magnetic layer over the glass substrate was set facing the Ti target, then Ar gas was injected such that its pressure became 0.5 Pa, and as the first nonmagnetic orientation layer the Ti seed layer was formed at 1,000 W (DC) to form a layer of 5 nm in thickness.

### <Formation of Second Nonmagnetic Orientation Layer>

Subsequently, as the second nonmagnetic orientation layer, a Ru layer of 10 nm in thickness was formed.

The first nonmagnetic orientation layer formed over the substrate was set facing the Ru target, then Ar gas was injected such that its pressure became 0.5 Pa, and as the second nonmagnetic orientation layer a Ru layer was formed at 1,000 W (DC) to form a layer of 10 nm in thickness.

### <Formation of Magnetic Recording Layer>

Then, as the magnetic recording layer, a CoCrPtO layer of 15 nm in thickness was formed.

Specifically, the second nonmagnetic orientation layer formed over the substrate was set facing the CoPtCr target, then Ar gas containing 0.04% O₂ was injected such that its pressure became 18 Pa, and the magnetic recording layer was formed at 290 W (DC).

### <Formation of Protective Layer>

After the formation of the magnetic recording layer, the magnetic recording layer formed over the substrate was set facing a C target, then Ar gas was injected such that its pressure became 0.5 Pa, the C protective layer of 4 nm in thickness was formed at 1,000 W (DC).

The coercive force of the magnetic recording medium thus obtained was 334 kA/m (4.2 kOe).

The primary nonmagnetic material of a magnetic recording medium of this Example is, for example, PtO.

### <Formation of Imprint Resist Layer>

As an imprint resist composition, an acrylic resist (PAK-01-500, manufactured by Toyo Gosei Co., Ltd.) was applied onto the thus prepared protective layer by spin coating (at 3,600 rpm) to form an imprint resist layer of 100 nm in thickness.

### <<Viscosity of Imprint Resist Composition>>

The viscosity of the imprint resist composition was measured using an ultrasonic viscosity meter. The result is shown in Table 1.

### <Calculation of P/NW>

The value of P/NW was calculated from the above results. The result is shown in Table 1.

### <Transfer Step>

The surface of the above mold onto which a concavo-convex pattern had been formed was set facing a substrate covered by an imprint resist layer to attach the substrate covered by the imprint resist layer under a pressure of 3 MPa for 10 sec to the surface. The substrate covered by the imprint resist layer was exposed to UV at a dose of 10 mJ/cm².

After the completion of the above steps, the mold was separated from the substrate onto which the imprint resist layer had been formed.

Subsequently, a residual imprint resist layer in concave portions of the substrate was removed by O₂ reactive chemical etching, where the concave portions were in the concavo-convex patterns in the imprint resist layer formed by transferring a concavo-convex pattern corresponding to the concavo-convex patterns of the mold onto the imprint resist layer. The O₂ reactive chemical etching was carried out so that the magnetic layer was exposed in the concave portions.

### <Magnetic Pattern Portion Forming Step>

After the residual imprint resist layer in the concave portions had been removed, a concavo-convex pattern was formed on the magnetic layer.

For forming a concavo-convex pattern on the magnetic layer, ion beam etching was employed.

Specifically, Ar gas was used with an ion accelerating energy of 500 eV and with an incident angle of the ion beam being perpendicular to the magnetic layer.

After a concavo-convex pattern had been thus formed on the magnetic layer, a residual resist on the magnetic layer was removed by O₂ reactive chemical etching.

Subsequently, a PFPE lubricant was applied onto the magnetic recording medium substrate with the magnetic layer having a concavo-convex pattern to form a layer of 2 nm in thickness by a Dip method.

### <Nonmagnetic Pattern Portion Forming Step>

After a concavo-convex pattern was formed on the magnetic layer, a SiO₂ layer was formed in the concavo-convex pattern by sputtering so that a complex layer of the SiO₂ layer and the magnetic material layer had a thickness of 50 nm. Subsequently the complex layer of the SiO₂ layer and the magnetic material layer was subjected to ion beam etching to remove redundant SiO₂ layer such that the height of the magnetic pattern portions became equal to that of the nonmagnetic pattern portions and that both portions had a common flat surface.

### <<Evaluation of Formability of Resist Pattern>>

The resist patterns were compared between data areas and servo areas of the substrates in which the surface corresponding to servo areas had not been coated, and NIL uniformity was evaluated as follows.

First, each of intermediate products of perpendicular magnetic recording media on which a resist pattern had been formed via a transfer step, were fractured, and then the film thickness of a resist residue remaining in the data areas and the height of resist patterns in burst areas in the servo areas were measured in cross-sections of the fractions using a scanning electron microscope (FE-SEM S800 manufactured by Hitachi, Ltd.). When the ratio of the height of the resist pattern in the burst area of the servo area and the height of the resist pattern in the data area was in the range of 0.95 to 1.0, the formability of resist pattern was evaluated as “A”; when the ratio was in the range of 0.90 to less than 0.95 the resist pattern formability was evaluated as “B”, when the ratio was in the range of 0.85 to less than 0.90 the resist pattern formability was evaluated as “C”, and when the ratio was in the range less than 0.85 the resist pattern formability was evaluated as “D”.

The thicknesses of the resist samples were measured at eight sites per disc within an area having a radius of 20 mm at substantially equiangular spacing, and the average of the eight ratios was calculated to thereby evaluate the (average) resist pattern formability.

### <Evaluation of Magnetic Recording Medium>

### <<Evaluation of Signal Integrity of Servo Signal>>

On the prepared perpendicular magnetic recording media in which each of the magnetic layers had been formed, reproduction output powers of TAA (Track Average Amplitude) of a preamble area and a burst area were detected for all the sectors. For an evaluation apparatus, LS-90 (manufactured by Kyodo Denshi, K. K.) was used. A GMR head having a read width of 120 nm and a write width of 200 nm was mounted to the apparatus.

In each of the perpendicular magnetic recording media, points were measured for reproduction output powers of TAA at 1 mm intervals in a radial direction from a radius of 20 mm to a radius of 32 mm of the recording medium to calculate the average reproduction output power for the preamble area and the burst area. When the ratio of the average output power of the burst areas to the average output power of the preamble areas was in the range of 0.8 to 1.0, the signal integrity of servo signals was evaluated as “A”; when the ratio was in the range of 0.6 to less than 0.8, the signal integrity of servo signals was evaluated as “B”; and when the ratio was in the range less than 0.6, the signal integrity of servo signals was evaluated as “C”. Note that the servo signals evaluated as “A” and “B” are usable.

In addition, uniformity of the signals was evaluated. A standard deviation (σ) of the ratios of the output power of the preamble area and that of the ratios of the output power of the burst area were calculated to introduce a 3σ value. When an absolute value of [3σ value]/[average value] was less than 0.05, the uniformity of the output power of the signals was evaluated as “A”, when the absolute value was in the range of 0.05 to less than 0.1, the uniformity of the output power of the signals was evaluated as “B”, and when the absolute value was in the range of 0.1 or more, the uniformity of the output power of the signals was evaluated as “C”.

### Example 2

### <Preparation of Imprint Mold Structure>

An imprint mold structure was prepared in the same manner as in Example 1, except that a concavo-convex pattern in a servo area was extended to an area of the imprint mold structure corresponding to the outermost circumferential edge of a pattern forming area of a magnetic recording medium.

Note that a dummy pattern with the dimension indicated in Table 1 was provided in an area of the imprint mold structure corresponding to the area on the magnetic recording medium substrate which extends externally from the outermost circumferential edge of the pattern forming area.

### <<Measurement of Width of Concavo-Convex Pattern in Servo Area>>

For the imprint mold structure thus prepared, the width of a concavo-convex pattern in a servo area was measured in the same manner as in Example 1. The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used in place of the imprint mold structure prepared in Example 1.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 3

### <Preparation of Imprint Mold Structure>

An imprint mold structure was prepared in the same manner as in Example 1, except that a concavo-convex pattern in a servo area reached the two edges corresponding to the two edges of the pattern forming area of a magnetic recording medium, that is the innermost circumferential edge and the outermost circumferential edge of a pattern forming area.

Note that the two dummy patterns with dimensions indicated in Table 1 were provided such that each corresponding dummy pattern of the magnetic recording medium extends from the innermost circumferential edge or from the outermost circumferential edge of the pattern forming area.

### <<Measurement of Width of Concavo-Convex Pattern in Servo Area>>

For the imprint mold structure thus prepared, the width of a concavo-convex pattern in a servo area was measured in the same manner as in Example 1. The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used in place of the imprint mold structure prepared in Example 1.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 3 for the magnetic recording medium thus prepared. The result is shown in Table 1.

### Example 4

### <Preparation of Imprint Mold Structure>

In this Example, an imprint mold structure was prepared in the same manner as in Example 3.

### <<Measurement of Width of Concavo-Convex Pattern in Servo Area>>

For the imprint mold structure thus prepared, the width of a concavo-convex pattern in a servo area was measured in the same manner as in Example 1. The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1, except that an acrylic resist (PAK-01-60, manufactured by Toyo Gosei Co., Ltd.) was used in place of the imprint resist composition of Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint resist composition described in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 5

### <Preparation of Imprint Mold Structure>

An imprint mold structure was prepared in the same manner as in Example 3.

### <<Measurement of Width of Concavo-Convex Pattern in Servo Area>>

For the imprint mold structure thus prepared, the widths of a concavo-convex pattern in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1, except that an acrylic resist (PAK-01, manufactured by Toyo Gosei Co., Ltd.) diluted with acetone by twofold, was used in place of the imprint resist composition of Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 6

### <Preparation of Imprint Mold Structure>

An imprint mold structure was prepared in the same manner as in Example 3, except that WO was changed as shown in Table 1.

### <<Measurement of Width of Concavo-Convex Pattern in Servo Area>>

For the imprint mold structure thus prepared, the widths of a concavo-convex pattern in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 5.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 7

### <Preparation of Imprint Mold Structure>

An imprint mold structure was prepared in the same manner as in Example 3, except that WO was changed as shown in Table 1.

### <<Measurement of Width of Concavo-Convex Pattern in Servo Area>>

For the imprint mold structure thus prepared, the widths of a concavo-convex pattern in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 5.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 8

### <Preparation of Imprint Mold Structure>

An imprint mold structure was prepared in the same manner as in Example 3, except that WO was changed as shown in Table 1.

### <<Measurement of Width of Concavo-Convex Pattern in Servo Area>>

For the imprint mold structure thus prepared, the widths of a concavo-convex pattern in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 5.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 9

### <Preparation of Imprint Mold Structure>

An imprint mold structure was prepared in the same manner as in Example 8, except that N was changed as shown in Table 1.

### <<Measurement of Width of Concavo-Convex Pattern in Servo Area>>

For the imprint mold structure thus prepared, the widths of a concavo-convex pattern in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 5.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 10

### <Preparation of Imprint Mold Structure>

An imprint mold structure was prepared in the same manner as in Example 3.

### <<Measurement of Width of Concavo-Convex Pattern in Servo Area>>

For the imprint mold structure thus prepared, the widths of a concavo-convex pattern in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1, except that an acrylic resist (PAK-01-60, manufactured by Toyo Gosei Co., Ltd.) diluted with acetone by 5/4-fold, was used in place of the imprint resist composition of Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 11

### <Preparation of Imprint Mold Structure>

An imprint mold structure was prepared in the same manner as in Example 3.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1, except that an acrylic resist (PAK-01, manufactured by Toyo Gosei Co., Ltd.) was used in place of the imprint resist composition of Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared for this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 12

### <Preparation of Imprint Mold Structure>

An imprint mold structure was prepared in the same manner as in Example 1, except that a dummy pattern with the dimension indicated in Table 1 was provided in an area of the imprint mold structure corresponding to the area on a magnetic recording medium substrate which extends internally from the innermost circumferential edge of the pattern forming area.

### <<Measurement of Width of Concavo-Convex Pattern of Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 13

### <Preparation of Imprint Mold Structure>

An imprint mold structure was prepared in the same manner as in Example 2, except that a dummy pattern with the dimension indicated in Table 1 was provided in an area of the imprint mold structure corresponding to an area on a magnetic recording medium substrate extending externally from the outermost circumferential edge of the pattern forming area.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 14

### <Preparation of Imprint Mold Structure>

An imprint mold structure was prepared in the same manner as in Example 1, except that a dummy pattern with the dimension indicated in Table 1 was provided in an area of the imprint mold structure corresponding to the area on a magnetic recording medium substrate which extends internally from the innermost circumferential edge of the pattern forming area.

### <Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 15

### <Preparation of Imprint Mold Structure>

An imprint mold structure was prepared in the same manner as in Example 2, except that a dummy pattern with the dimension indicated in Table 1 was provided in an area of the imprint mold structure corresponding to the area on a magnetic recording medium substrate which extends externally from the outermost circumferential edge of the pattern forming area.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 16

### <Preparation of Imprint Mold Structure>

An imprint mold structure was prepared in the same manner as in Example 3, except that the dimension of a dummy pattern of the imprint mold structure corresponding to the dummy pattern of a magnetic recording medium which extends externally from the outermost circumferential edge of a pattern forming area, was changed as shown in Table 1.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Example 17

### <Preparation of Imprint Mold Structure>

An imprint mold structure was prepared in the same manner as in Example 3, except that the dimension of a dummy pattern of the imprint mold structure corresponding to the dummy pattern of a magnetic recording medium substrate which extends internally from the innermost circumferential edge of a pattern forming area, was changed as shown in Table 1.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Comparative Example 1

### <Preparation of Imprint Mold Structure>

An imprint mold structure was prepared in the same manner as in Example 8, except that no dummy pattern was provided in the imprint mold structure of this Comparative Example.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Example 8.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Comparative Example 2

### <Preparation of Imprint Mold Structure>

An imprint mold structure was prepared in the same manner as in Comparative Example 1.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Comparative Example 1, except that an acrylic resist (PAK-01-60, manufactured by Toyo Gosei Co., Ltd.) diluted with acetone by 5/4-fold, was used in place of the imprint resist composition of Comparative Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared in this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

### Comparative Example 3

### <Preparation of Imprint Mold Structure>

An imprint mold structure was prepared in the same manner as in Comparative Example 1.

### <<Measurement of Width of Concavo-Convex Pattern in Servo Area>>

For the imprint mold structure thus prepared, the widths of concavo-convex patterns in a servo area (WO and WI) were measured in the same manner as in Example 1 to calculate the ratio thereof (WO/WI). The results are shown in Table 1.

### <<Number of Convex Portions or Concave Portions of Servo Area>>

For the imprint mold structure thus prepared, the number of convex portions or concave portions of the servo areas was counted in the same manner as in Example 1. The result is shown in Table 1.

### <Formation of Imprint Resist Layer>

An imprint resist layer was provided in the same manner as in Comparative Example 1, except that an acrylic resist (PAK-01, manufactured by Toyo Gosei Co., Ltd.) was used in place of the imprint resist composition of Comparative Example 1.

### <<Viscosity of Imprint Resist Composition>>

The viscosity of the imprint resist composition was measured in the same manner as in Example 1. The result is shown in Table 1.

### <Preparation of Magnetic Recording Medium>

A magnetic recording medium was prepared in the same manner as in Example 1, except that the imprint mold structure prepared for this Example was used.

### <Calculation of P/NW>

The value of P/NW was calculated from the above results. The result is shown in Table 1.

### <<Evaluation of Formability of Resist Pattern>>

The formability of a resist pattern was evaluated in the same manner as in Example 1 in the preparation of the magnetic recording medium. The result is shown in Table 1.

### <Evaluation of Magnetic Recording Medium>

The signal integrity of servo signals was evaluated in the same manner as in Example 1 for the magnetic recording medium thus prepared. The result is shown in Table 1.

TABLE 1

| | Dimension of | Dimension of | | | | | | | | | | | | |
|---|---|---|---|---|---|---|---|---|---|---|---|---|---|---|
| | dummy | dummy | | | | | | | | | | | | |
| | pattern of | pattern of | | | | | | | | | | | | |
| | innermost | outermost | | | | | | | Formability | | Servo | E- | Servo | E- |
| | circumferential | circumferential | WO | WI | WO/ | | | | of resist | Evalu- | property | valu- | property | valu- |
| | edge (mm) | edge (mm) | (nm) | (nm) | WI | N | P | P/NW | pattern | ation | (output) | ation | (uniformity) | ation |
| Ex. 1 | 0.25 | 0 | 0.14 | 0.14 | 1.00 | 50 | 2 | 0.0400 | 0.86 | C | 0.79 | B | 0.06 | B |
| Ex. 2 | 0 | 0.25 | 0.14 | 0.14 | 1.00 | 50 | 2 | 0.0400 | 0.87 | C | 0.77 | B | 0.07 | B |
| Ex. 3 | 0.25 | 0.25 | 0.14 | 0.14 | 1.00 | 50 | 2 | 0.0400 | 0.91 | B | 0.79 | B | 0.04 | A |
| Ex. 4 | 0.25 | 0.25 | 0.14 | 0.14 | 1.00 | 50 | 0.5 | 0.0100 | 0.93 | B | 0.85 | A | 0.03 | A |
| Ex. 5 | 0.25 | 0.25 | 0.14 | 0.14 | 1.00 | 50 | 10 | 0.2000 | 0.94 | B | 0.81 | A | 0.04 | A |
| Ex. 6 | 0.25 | 0.25 | 0.2 | 0.14 | 1.43 | 50 | 10 | 0.1400 | 0.92 | B | 0.85 | A | 0.03 | A |
| Ex. 7 | 0.25 | 0.25 | 0.4 | 0.14 | 2.86 | 50 | 10 | 0.0700 | 0.94 | B | 0.84 | A | 0.02 | A |
| Ex. 8 | 0.25 | 0.25 | 0.28 | 0.14 | 2.00 | 50 | 10 | 0.1000 | 0.97 | A | 0.92 | A | 0.02 | A |
| Ex. 9 | 0.25 | 0.25 | 0.28 | 0.14 | 2.00 | 240 | 10 | 0.0208 | 0.98 | A | 0.94 | A | 0.01 | A |
| Ex. 10 | 0.25 | 0.25 | 0.14 | 0.14 | 1.00 | 50 | 0.4 | 0.0080 | 0.93 | B | 0.85 | A | 0.04 | A |
| Ex. 11 | 0.25 | 0.25 | 0.14 | 0.14 | 1.00 | 50 | 20 | 0.4000 | 0.89 | C | 0.76 | B | 0.04 | A |
| Ex. 12 | 0.09 | 0 | 0.14 | 0.14 | 1.00 | 50 | 2 | 0.0400 | 0.85 | C | 0.69 | B | 0.06 | B |
| Ex. 13 | 0 | 0.09 | 0.14 | 0.14 | 1.00 | 50 | 2 | 0.0400 | 0.86 | C | 0.7 | B | 0.08 | B |
| Ex. 14 | 1.1 | 0 | 0.14 | 0.14 | 1.00 | 50 | 2 | 0.0400 | 0.87 | C | 0.79 | B | 0.04 | A |
| Ex. 15 | 0 | 1.1 | 0.14 | 0.14 | 1.00 | 50 | 2 | 0.0400 | 0.88 | C | 0.71 | B | 0.03 | A |
| Ex. 16 | 0.25 | 0.75 | 0.14 | 0.14 | 1.00 | 50 | 2 | 0.0400 | 0.96 | A | 0.91 | A | 0.02 | A |
| Ex. 17 | 0.75 | 0.25 | 0.14 | 0.14 | 1.00 | 50 | 2 | 0.0400 | 0.97 | A | 0.89 | A | 0.02 | A |
| Comp. | 0 | 0 | 0.28 | 0.14 | 2.00 | 50 | 10 | 0.1000 | 0.76 | D | 0.59 | C | 0.15 | C |
| Ex. 1 | | | | | | | | | | | | | | |
| Comp. | 0 | 0 | 0.28 | 0.14 | 2.00 | 50 | 0.4 | 0.0040 | 0.81 | D | 0.58 | C | 0.12 | C |
| Ex. 2 | | | | | | | | | | | | | | |
| Comp. | 0 | 0 | 0.28 | 0.14 | 2.00 | 50 | 20 | 0.2000 | 0.75 | D | 0.56 | C | 0.19 | C |
| Ex. 3 | | | | | | | | | | | | | | |

As shown in Table 1, Examples 1 to 17, in which at at least any one of an inner circumferential edge and an outer circumferential edge of concavo-convex pattern in a data area or a servo area with respect to the center of a disc-shaped substrate of the imprint mold structure a dummy pattern is formed which corresponds to the pattern on a magnetic recording medium substrate which extends radially from at least any one of an inner circumferential edge and an outer circumferential edge of a pattern forming area, could provide an imprint mold structure with higher transferability than Comparative Examples 1 to 3 could, in which no dummy pattern had been formed for their imprint mold structures.

A magnetic recording medium excellent in recording and reproducing property could be provided by using an imprint mold structure prepared in each of Examples 1 to 17, in which at at least any one of an inner circumferential edge and an outer circumferential edge of concavo-convex pattern of a data area or a servo area with respect to the center of a disc-shaped substrate of the imprint mold structure a dummy pattern is formed which corresponds to a pattern on a magnetic recording medium substrate extending radially from at least any one of an inner circumferential edge and an outer circumferential edge of a pattern forming area.

Particularly, Example 8 in which the ratio of the width of the outermost circumference (WO) to the width of the innermost circumference (WI) was in the range of 1.5 to 2.8, and Example 9 in which the ratio of the width of the outermost circumference (WO) to the width of the innermost circumference (WI) was in the range of 1.5 to 2.8 and in which the number of convex portions or concave portions of the servo areas (N) was in the range of 60 to 300, could provide imprint mold structures and magnetic recording media which were excellent in formability of resist patterns.

What is claimed is:

1. An imprint mold structure comprising,
a disc-shaped substrate having on a surface thereof concavo-convex patterns in a data area and in a servo area,
wherein the concavo-convex pattern in the data area is formed by forming a plurality of convex portions along concentric circumferences on the surface of the disc-shaped substrate, and
the concavo-convex pattern in the servo area is formed by radially forming ridges of a plurality of convex portions on the surface of the disc-shaped substrate,
wherein the imprint mold structure is used for transferring the concavo-convex pattern onto an imprint resist layer, which is composed of an imprint resist composition formed on a disc-shaped magnetic recording medium substrate, by pressing the concavo-convex patterns in the data area and in the servo area against the imprint resist layer, and
wherein at at least any one of an inner circumferential edge and an outer circumferential edge of the concavo-convex pattern in the servo area relative to the center of the disc-shaped substrate of the imprint mold structure, a dummy pattern is formed, which extends radially from at least any one of an inner circumferential edge and an outer circumferential edge of a pattern forming area on the magnetic recording medium substrate.

2. The imprint mold structure according to claim 1,
wherein the dimension of regions of the dummy pattern in a radial direction on the imprint mold structure is in the range of 0.1 mm to 1.0 mm.

3. The imprint mold structure according to claim 1,
wherein the width of the concavo-convex pattern in the servo area along the outermost circumference (WO) is larger than the width of the concavo-convex pattern in the servo area along the innermost circumference (WI).

4. The imprint mold structure according to claim 1,
wherein the ratio of the width of the concavo-convex pattern in the servo area along the outermost circumference (WO) to the width of the concavo-convex pattern in the servo area along the innermost circumference (WI) (W: W=WO/WI) is in the range of 1.5 to 2.8.

5. The imprint mold structure according to claim 1,
wherein the number (N) of convex portions or concave portions of the servo area is in the range of 60 to 300.

6. An imprinting method comprising
transferring a concavo-convex pattern onto an imprint resist layer formed on a magnetic recording medium substrate, by pressing against the imprint resist layer an imprint mold structure which comprises,
a disc-shaped substrate having on a surface thereof concavo-convex patterns in a data area and in a servo area,
wherein the concavo-convex pattern in the data area is formed by forming a plurality of convex portions along concentric circumferences on the surface of the disc-shaped substrate, and
the concavo-convex pattern in the servo area is formed by radially forming ridges of a plurality of convex portions on the surface of the disc-shaped substrate,
wherein the imprint mold structure is used for transferring the concavo-convex pattern onto the imprint resist layer, which is composed of an imprint resist composition formed on the disc-shaped magnetic recording medium substrate, by pressing the concavo-convex patterns in the data area and in the servo area against the imprint resist layer, and
wherein at at least any one of an inner circumferential edge and an outer circumferential edge of the concavo-convex pattern in the servo area with respect to the center of the disc-shaped substrate of the imprint mold structure, a dummy pattern is formed, which extends radially from at least any one of an inner circumferential edge and an outer circumferential edge relative to a pattern forming area on the magnetic recording medium substrate.

7. The imprinting method according to claim 6,
wherein conditions for the imprinting method satisfy the following Mathematical Expression 1:
0.001≦P/NW<0.45 Mathematical Expression 1
wherein P represents the viscosity of the imprint resist composition, W represents the ratio of the width of the concavo-convex pattern in the servo area along the outermost circumference (WO) to the width of the concavo-convex pattern in the servo area along the innermost circumference (WI) (W=WO/WI), and N represents the number of convex portions or concave portions of the servo area.

8. The imprinting method according to claim 6,
wherein the width of the concavo-convex pattern in the servo area along the outermost circumference (WO) is larger than the width of the concavo-convex pattern in the servo area along the innermost circumference (WI).

9. The imprinting method according to claim 6,
wherein the ratio of the width of the concavo-convex pattern in the servo area along the outermost circumference (WO) to the width of the concavo-convex pattern in the servo area along the innermost circumference (WI) (W: W=WO/WI) is in the range of 1.5 to 2.8.

10. The imprinting method according to claim 6,
wherein the number (N) of convex portions or concave portions of the servo area is in the range of 60 to 300.

11. A magnetic recording medium comprising:
a magnetic pattern portion and
a nonmagnetic pattern portion,
wherein the magnetic recording medium is manufactured by a method for manufacturing a magnetic recording medium which comprises
transferring a concavo-convex pattern onto an imprint resist layer formed on a magnetic recording medium substrate,
forming on a first area of a magnetic layer the magnetic pattern portion of the data area corresponding to the concavo-convex pattern in the data area formed on the imprint mold structure and forming on a second area of the magnetic layer the magnetic pattern portion of the servo area corresponding to the concavo-convex pattern in the servo area formed on the imprint mold structure by etching the first and second area of the magnetic layer formed on a surface of the magnetic recording medium substrate using as a mask the imprint resist layer onto which the concavo-convex pattern has been transferred, and
forming the nonmagnetic pattern portion by embedding a nonmagnetic material in a concave portion formed on the magnetic layer,
wherein the width of the magnetic pattern portion of the servo area along the outermost circumference (WO) is larger than the width of the magnetic pattern portion of the servo area along the innermost circumference (WI), and
wherein the concavo-convex pattern has been transferred onto the imprint resist layer formed on the magnetic recording medium substrate, by pressing against the imprint resist layer the imprint mold structure which comprises,
a disc-shaped substrate having on a surface thereof the concavo-convex patterns in the data area and in the servo area,
wherein the concavo-convex pattern in the data area is formed by forming a plurality of convex portions along concentric circumferences on the surface of the disc-shaped substrate, and
the concavo-convex pattern in the servo area is formed by radially forming ridges of a plurality of convex portions on the surface of the disc-shaped substrate,
wherein the imprint mold structure is used for transferring the concavo-convex pattern onto the imprint resist layer, which is composed of an imprint resist composition formed on the disc-shaped magnetic recording medium substrate, by pressing the concavo-convex patterns in the data area and in the servo area against the imprint resist layer, and
wherein at at least any one of an inner circumferential edge and an outer circumferential edge of the concavo-convex pattern in the servo area with respect to the center of the disc-shaped substrate of the imprint mold structure, a dummy pattern is formed, which extends radially from at least any one of an inner circumferential edge and an outer circumferential edge relative to a pattern forming area on the magnetic recording medium substrate.

12. The magnetic recording medium according to claim 11,
wherein the ratio of the width of the magnetic pattern portion of the servo area along the outermost circumference (WO) to the width of the magnetic pattern portion of the servo area along the innermost circumference (WI) (W: W=WO/WI) is in the range of 1.5 to 2.8.

13. The magnetic recording medium according to claim 11,
wherein the number of magnetic pattern portions of the servo area (N) is in the range of 60 to 300.

14. The magnetic recording medium according to claim 11,
wherein the magnetic pattern portions of the servo area are servo pattern.

15. The magnetic recording medium according to claim 11,
wherein the magnetic recording medium satisfies the following Mathematical Expression 1:
0.001≦P/NW<0.45 Mathematical Expression 1
wherein P represents the viscosity of the imprint resist composition, W represents the ratio of the width of the magnetic pattern portion of the servo area along the outermost circumference (WO) to the width of the magnetic pattern portion of the servo area along the innermost circumference (WI) (W=WO/WI), and N represents the number of magnetic pattern portions of the servo area.
